(19) United States
(12) Patent Application Publication
(10) Pub. No.: US 2015/0262150 A1
(43) Pub. Date: Sep. 17, 2015

(54) Method of Producing a Check using an ATM

(71) Applicant: Renee Morgan, St Andrew (JM)

(72) Inventor: Renee Morgan, St Andrew (JM)

(21) Appl. No.: 14/210,553

(22) Filed: Mar. 14, 2014

(51) Int. Cl. G06Q 20/10; G07F 19/00

(52) U.S. Cl. CPC G06Q 20/1085; G07F 19/202; G07F 19/203

(57) ABSTRACT

Embodiments of the disclosed technology are directed to a device and/or method for drafting, printing, and/or sending a negotiable instrument, such as a check or money order. An automated teller machine (ATM) performs numerous electronic banking functions, including the execution of a check from a user's bank account. The user accesses the features of the ATM by inserting a bank card and entering security credentials. Amongst the other functions of an ATM, the ATM may be directed to draft a negotiable instrument payable to a payee or cash. The user may enter an amount, name of a payee, and other relevant information before dispatching the negotiable instrument. The user may then select a delivery method of dispatching the instrument. The available delivery methods may be printing, and/or mail to the recipient's address.

### FIELD OF THE DISCLOSED TECHNOLOGY

The disclosed technology relates generally to electronic banking, and, more particularly, to using an ATM to print a check.

### BACKGROUND OF THE DISCLOSED TECHNOLOGY

Automated transaction machines include automated banking machines. A common type of automated banking machine is an automated teller machine (ATM). ATMs may be used to perform transactions such as dispensing cash, accepting deposits, responding to account balance inquiries, paying bills, and transferring funds between accounts. ATMs and other types of automated banking machines may be used to dispense media or documents such as currency, tickets, scrip, vouchers, checks, gaming materials, receipts, or other media. While many types of automated banking machines, including ATMs, are operated by consumers, other types of automated banking machines may be operated by service providers. Such automated banking machines may be used by service providers to supply cash or other types of sheets or documents when performing transactions. For purposes of this disclosure, an automated banking machine or ATM shall be construed as any machine that is capable of carrying out transactions which include transfers of value.

While the latest ATMs have much broader functionality than those previously in use, none exist which can facilitate the transfer of money to a payee via execution of a check or other negotiable instrument. Thus, needed in the art is an automated and electronic way of drafting, sending and/or printing a check and/or money order.

### SUMMARY OF THE DISCLOSED TECHNOLOGY

Therefore, it is an object of the disclosed technology to provide a device and/or method for drafting, printing, and/or sending a negotiable instrument, such as a check or money order.

Accordingly, a device and/or method are provided for drafting, printing, and/or sending a negotiable instrument, such as a check or money order. An automated teller machine (ATM) performs numerous electronic banking functions, including the execution of a check from a user's bank account. The user accesses the features of the ATM by inserting a bank card and entering security credentials. Amongst the other functions of an ATM is the instruction to draft a negotiable instrument payable to a payee, or cash. The user may enter an amount, the name of a payee, and other relevant information before dispatching the negotiable instrument. The user may then select a delivery method of dispatching the instrument. The available delivery methods may be printing, and/or mail to the recipient's address.

In an embodiment of the disclosed technology, a method is used for generating and printing a certified bank check. A “certified check” is defined as a check for which the bank verifies that sufficient funds exist in the account to cover the check at the time the check is written. The method is carried out, not necessarily in the following order, by: a) authorizing an account holder access to an account of the account holder via an interface physically located on an ATM associated with a bank; b) receiving from the account holder an amount and a type of certified bank check to be printed; c) confirming that the account associated with the user has sufficient funds to cover the inputted amount; and/or d) printing the certified bank check on paper with printed insignia and data designed for exclusive use by the bank.

In further embodiments of the disclosed method, the insignia confirm authenticity of the certified bank check. When the check is printed, funds in the account may be associated with the check and/or set aside. An additional step may be provided of inputting payee information at the ATM to be populated to the check. Furthermore, the payee may be chosen from a list of possible payees, each payee in the list of payees being authorized by the bank. In a further embodiment, the money used to fund the check may be deposited into the ATM by the user at the time of generating the check. That is, the money may be deposited in the form of cash or other instrument during the same transaction as the printing of the check.

In an embodiment of the disclosed technology, a method is used for generating and printing a negotiable instrument. A “negotiable instrument” is defined as any document guaranteeing the payment of a specific amount of money, either on demand (i.e., in cash), or at a set time, with the payer named on the negotiable instrument. The method is carried out, not necessarily in the following order, by: a) confirming a user as an authorized user of an account via an interface physically located on an automated teller machine (ATM); b) receiving from the account holder an amount and a type of negotiable instrument to be printed; c) confirming that the account has sufficient funds to cover the inputted amount; d) generating the negotiable instrument; and/or e) delivering the negotiable instrument via a method selected by the user.

In embodiments, the delivery method may be either: a) printing the negotiable instrument using a printer associated with the ATM; or b) mailing the negotiable instrument to an address of the payee. Alternatively, if the amount of the check exceeds a pre-specified threshold, additional security measures may be enacted regarding the delivery of the negotiable instrument. The additional security measures may involve the negotiable instrument being printed at a branch of the bank for pick-up by the user, and/or capturing an image of the user using a camera associated with the ATM.

In still another embodiment of the disclosed technology, an ATM has a touch display, a processor, and a printer. The printer is used to print a negotiable instrument generated by the ATM. The negotiable instrument may be a check, drafted by a user using the touch display. The ATM may also have a stylus for endorsing a visualization of the negotiable instrument on the display prior to printing. The ATM may further employ a camera for capturing an image of a user of the ATM.

It should be understood that the use of “and/or” is defined inclusively such that the term “a and/or b” should be read to include the sets: “a and b,” “a or b,” “a,” “b.” Further details are set forth in the detailed description below.

### BRIEF DESCRIPTION OF THE DRAWINGS

FIG. 1 shows a front elevation view of an automated teller machine according to embodiments of the disclosed technology.

FIG. 2 shows a perspective view of an automated teller machine according to embodiments of the disclosed technology.

FIG. 3 shows the automated teller machine of FIG. 2 printing a check according to embodiments of the disclosed technology.

FIG. 4 shows a flow chart of steps used in carrying out methods of the disclosed technology.

FIG. 5 shows a high-level block diagram of a microprocessor device that may be used to carry out the disclosed technology.

### DETAILED DESCRIPTION OF EMBODIMENTS OF THE DISCLOSED TECHNOLOGY

Embodiments of the disclosed technology are directed to a device and/or method for drafting, printing, and/or sending a negotiable instrument, such as a check or money order. An automated teller machine (ATM) performs numerous electronic banking functions including the execution of a check from a user's bank account. The user accesses the features of the ATM by inserting a bank card and entering security credentials. Amongst the other functions of an ATM, the ATM may be directed to draft a negotiable instrument payable to a payee or pay out cash. The user may enter an amount, the name of a payee, and other relevant information before dispatching the negotiable instrument. The user may then select a delivery method of dispatching the instrument. The available delivery methods may be printing, and/or mail to the recipient's address.

Embodiments of the disclosed technology will become clearer in view of the following description of the figures.

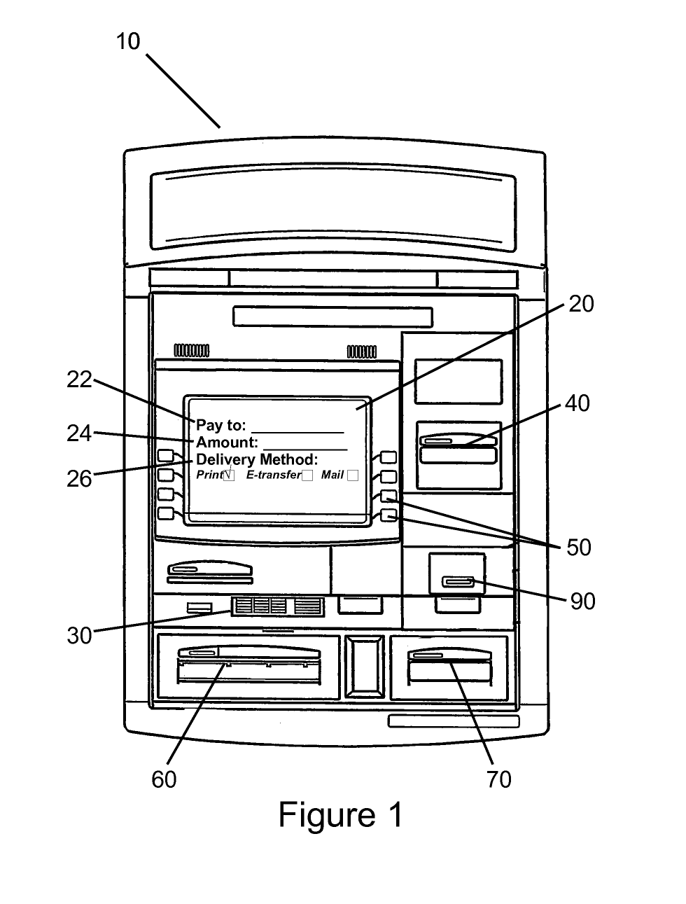

FIG. 1 shows a front elevation view of an automated teller machine, according to embodiments of the disclosed technology. A banking system that is controlled by data-bearing records includes the automated banking machine 10. The automated banking machine 10 can be an automated teller machine (ATM). The ATM can include one or more cash dispensers. A cash dispenser includes one or more mechanisms that operate to selectively dispense cash stored within the machine to users of the machine. The automated banking machine 10 includes a display 20 which serves as a user interface (or customer interface).

The automated banking machine 10 includes a housing which houses certain components of the machine. The components of the machine can include input and output devices. The input devices may include a card reader device 40. The card reader device 16 may be operative to read data-bearing records presented by machine users. Such records can include data corresponding to at least one associated user, one or more user financial accounts, and/or other data. In an exemplary arrangement the card reader device 16 comprises a card reader that is operative to read data included on a customer's card. An exemplary card can include information about the customer thereon or therein, such as the customer's name, account number, and/or other data.

A card reader device 16 may comprise a magnetic stripe card reader which is able to read data from magnetic stripes of cards. However, in an exemplary embodiment, the card reader is operative to read data from other types of cards or records, such as contactless cards. For example, the card reader 16 may comprise a contactless card reader. Such a card reader may be operative to read data on radio-frequency identification (“RFID”) cards. Of course, these approaches are exemplary for purposes of this specification.

The automated banking machine 10 may include a keypad 30, function keys 50, a check outlet slot 70, and/or a cash outlet slot 60. It should be understood that these transaction function devices and features of the described ATM user interface are exemplary, and that in other embodiments the user interface may include different components and/or features and/or arrangements.

A printer (not shown) may reside within the check outlet slot 70 for printing checks and other negotiable instruments. The printer may store, amongst other items, a roll of paper and ink cartridges. The display 20 shows a check-drafting screen which a user may use to access the check execution feature. Of course, the user will have been granted security clearance prior to the display 20 showing the check-drafting screen. The security clearance may be granted upon the user inserting a bank card, typing a personal identification number (PIN), and/or carrying out further security measures.

It should be understood that, in various arrangements, other types of input devices may be used for security, such as biometric readers which may be operative to receive customer identifying inputs such as fingerprints, iris scans, retina scans, and face topography data that provide data usable to identify a user. One or more camera devices may also be used to serve as input devices for biometric features and the like. Other input devices, such as speech or voice recognition devices, facial recognition arrangements, inductance type readers, I type readers, and other types of devices which are capable of receiving information that identifies (or can be used to identify) a customer and/or his/her account may also be used.

Amongst other ATM features known in the art, the user may select an option on the display to execute the check-drafting feature. The display 20 shows examples of several fields to be filled out by the user in executing the check. In the present example, the user is prompted to enter a payee name in the “Pay to:” field 22 and an amount in the “Amount:” field 24. Furthermore, the user is prompted to select a “Delivery Method:” 26 for conveying the check. The delivery methods shown are “Print,”, and “Mail.” These delivery methods are exemplary, and other delivery methods known in the art are possible. For example, if the check exceeds a threshold amount, the user may be required to pick up the check at a local branch of the bank.

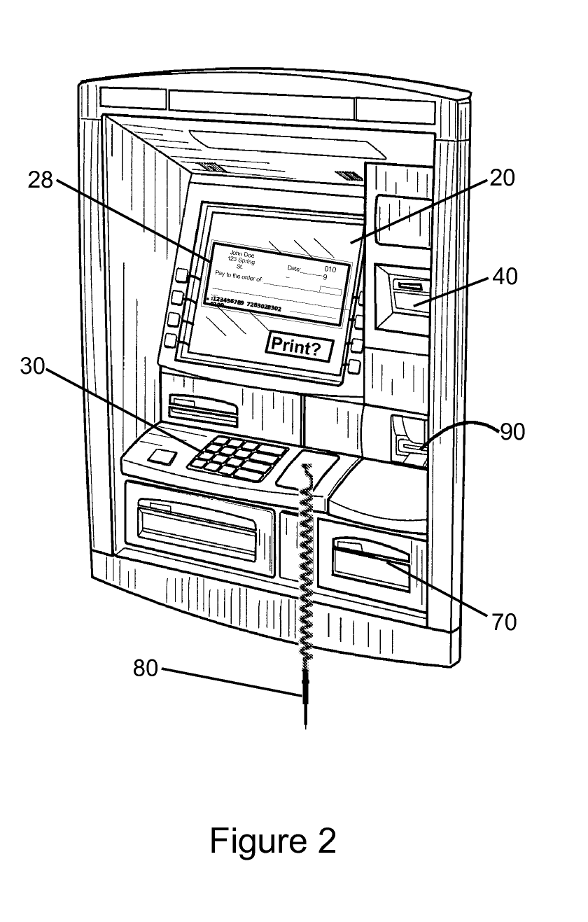

FIG. 2 shows a perspective view of an automated teller machine, according to embodiments of the disclosed technology. The keypad 30 can include a plurality of input keys which may be manually actuated by a customer to provide manual inputs to the machine. The function keys 50 can be used to permit a customer to respond to a screen prompt. The display 20 is viewable by an operator of the machine. The display enables outputs through a display screen. The display may also enable inputs through the display screen. Thus, the display can be a display type that enables both outputs and inputs. Therefore the display can be both an input device and an output device. For example, the display 20 may be a touch screen display which enables outputs through displays on the screen and enables customers to provide inputs by placing a finger adjacent to areas of the screen. A combined input and output device, such as a touch screen display, can provide outputs to a user, as well as receiving inputs from the user. The display 20 may include an LCD, plasma, CRT or other display type that is capable of providing visible indicia, such as still images or moving video, to a customer.

Further output devices associated with the exemplary user interface can include a speaker. A headphone jack can also be used to serve as an output device. A headphone jack may be connected to a headphone provided by a user who is visually impaired to provide the user with voice guidance in the operation of the machine. Alternatively, the automated banking machine 10 may provide a headphone for a customer. The automated banking machine 10 can also include a deposit acceptance area. The deposit acceptance area is an area through which deposits or deposit documents, such as deposit envelopes to be deposited by users, can be placed into the machine. The deposit acceptance area can include the document deposit opening. The deposit opening is in operative connection with a deposit accepting device positioned in a secure interior area of the machine.

Referring still to FIG. 2, the display 20 shows a visualization of an electronic version of the debit check 28 for user review prior to sending/printing/mailing. A electronic stylus pen 80 may be tethered to the automated transaction machine 10. The user may sign the generated check 28 on the display 20 or on a signature pad. In this embodiment, the entire check-executing method is electronic, and when finalized, the check may be printed.

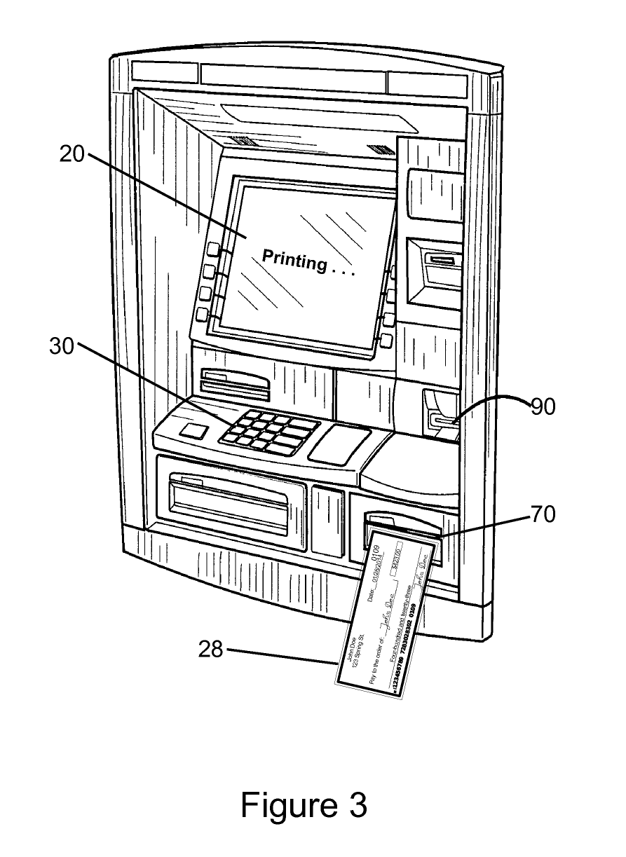

FIG. 3 shows the automated teller machine according to FIG. 2 printing a check, according embodiments of the disclosed technology. The check 28 is dispensed out of the check outlet slot 70 of the automated banking machine 10. Depending on the preference of the user, the check 28 may be signed and endorsed. Alternatively, a bank check, cashier check and/or money order may be printed which may not contain information about the user or the payee. Of course, stricter security measures should be followed if a money order or check written to cash is requested.

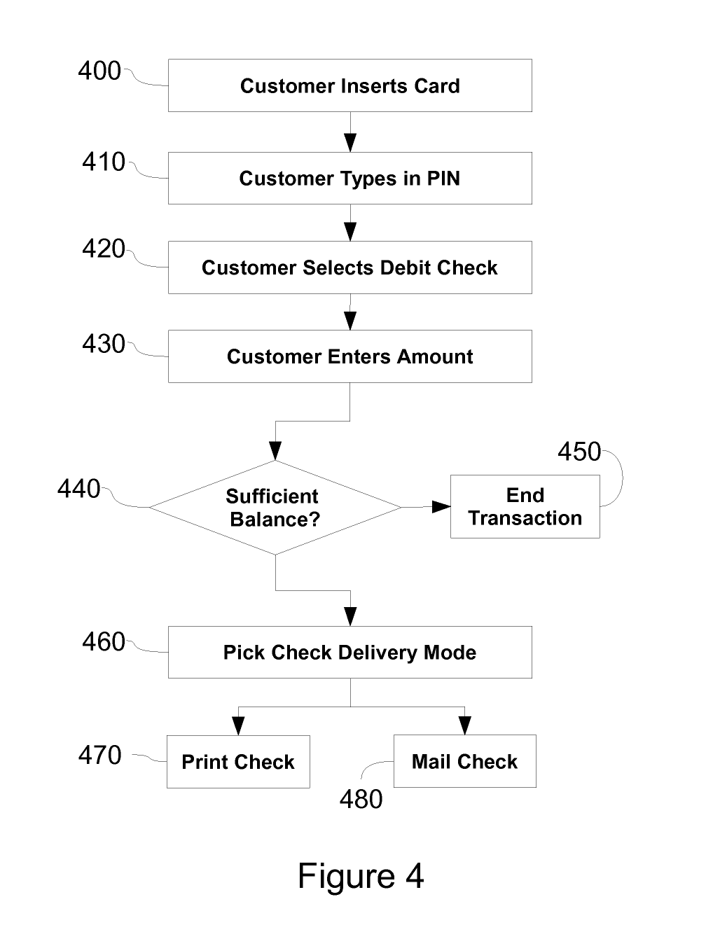

FIG. 4 shows a flow chart of steps used in carrying out exemplary methods of the disclosed technology. In step 400, the customer inserts a bank card into the automated banking machine. The bank card, as discussed, may be a debit card having a magnetic strip and associated bank account. Next, in step 410, the customer enters a personal identification number (PIN) or follows some other security protocol to ensure that the customer is an authorized user of the card. Upon entering a PIN, the customer may be presented with a number of typical ATM banking options. In step 420, the customer selects an option directed to generating a debit check or some other negotiable instrument.

In addition to other relevant information needed to draft a negotiable instrument, in step 430, the customer enters an amount for which the check will be written. Then, in step 440, it is determined whether there are sufficient funds in the customer's account to issue the check. If the funds are insufficient, then the transaction is ended in step 450. If sufficient funds exist in the customer's account, then the method proceeds to step 460, whereby a check delivery mode is chosen.

Numerous delivery modes may be available based on the amount and type of negotiable instrument chosen. The examples shown in FIG. 4 include printing the check (step 470), and mailing the check (step 480)). The delivery methods may be subject to certain restrictions. For example, if the amount of the check exceeds a pre-specified threshold amount, for security reasons, the payee may be required to pick up the check at a local branch of the bank, or a check may be written to a specific payee (e.g., not to cash).

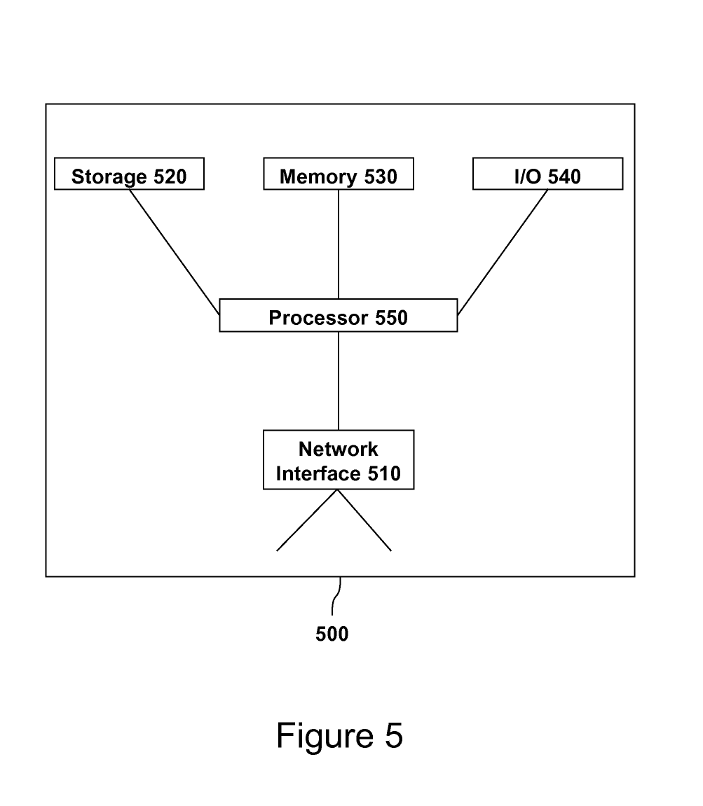

FIG. 5 shows a high-level block diagram of a microprocessor device that may be used to carry out the disclosed technology. The device 500 may or may not be a computing device. The device 500 comprises a processor 550 that controls the overall operation of a computer by executing the reader's program instructions which define such operation. The device's program instructions may be stored in a storage device 520 (e.g., magnetic disk, database) and loaded into memory 530 when execution of the console's program instructions is desired. Thus, the device's operation will be defined by its program instructions stored in memory 530 and/or storage 520, and the console will be controlled by the processor 550 executing the console's program instructions.

The device 500 may also include one or a plurality of input network interfaces for communicating with other devices via a network (e.g., the internet). The device 500 further includes an electrical input interface for receiving power and data from a power source. The device 500 may also include one or more output network interfaces 510 for communicating with other devices. The device 500 may also include input/output 540 representing devices which allow for user interaction with a computer (e.g., display, keyboard, mouse, speakers, buttons, etc.).

In an embodiment, in order to conduct transactions, the machine 10 can communicate with one or more computers remotely located from the machine. These remote computers are operative to exchange messages with the machine. For example, the remote computers may be used to authorize and record the occurrence of various transactions. The machine 10 may communicate through a network with a transaction host, such as a bank or financial transaction entity. The host has at least one computer which is operative to exchange messages with the machine. For example, a bank may receive one or more messages from the machine requesting authorization to allow a customer to withdraw $200 from the customer's account. A computer at the bank can operate to determine that such a withdrawal is authorized. The computer, or another computer affiliated therewith, can then return one or more messages to the machine through the network authorizing the machine to allow the withdrawal transaction.

In an embodiment, the processor 550 is operative to cause the communication of data corresponding to data read from a user's card. The read card data can be sent from the machine to a remote (bank) computer as part of one or more messages. The processor 550 may also communicate other data corresponding to user inputs to the remote computer, such as a personal identification number (PIN), a primary account number (PAN), and/or transaction request data.

The remote computer may be operable to compare the data corresponding to card data and/or PIN data to stored data, which corresponds to authorized users, in at least one data storage device associated with the remote computer. Responsive to the data corresponding to an authorized user and a permissible transaction request, the remote computer can communicate at least one message to the machine which corresponds to authorization to carry out the requested transaction. After the automatic transaction machine 10 conducts the functions to accomplish a transaction, such as dispensing cash, the machine can send one or more messages back through the network to the bank indicating that the transaction was successfully carried out. Of course, these message types are merely exemplary, and other transaction messages may be used.

It should be understood that in some embodiments the machine 10 may communicate with other entities and through various networks. For example, in an exemplary embodiment the machine can communicate with computers operated by machine service providers. Such service providers may comprise entities which are to be notified of status conditions or malfunctions of the machine, as well as entities which are to be notified of corrective actions. A service provider may be able to service a malfunctioning machine remotely via a network.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A method of generating and printing a certified bank check comprising:
authorizing an account holder access to an account of said account holder via an interface physically located on an automated teller machine (ATM) associated with a bank;
receiving from said account holder an amount of said certified bank check to be printed;
confirming that said account associated with said user has sufficient funds to cover said inputted amount; and
printing said certified bank check on paper with printed insignia and data designed for exclusive use by said bank.

2. The method of claim 1, wherein said insignia confirm authenticity of said certified bank check.

3. The method of claim 2, further comprising a step of associating funds in said account with said check equal to said amount.

4. The method of claim 3, further comprising a step of inputting payee information at said ATM to be imprinted on said check.

5. The method of claim 4, wherein said payee is chosen from a list of possible payees.

6. The method of claim 5, wherein each payee in said list of payees is pre-authorized by said bank at a time before said account holder presently uses said ATM.

7. The method of claim 6, wherein funds equivalent to said amount of said check are set aside only for use in honoring said check.

8. The method of claim 7, wherein money used to fund said check is deposited into said ATM by said user during the time of generating said check

9. A method of generating and printing a negotiable instrument comprising:
confirming a user as an authorized user of an account via an interface physically located on an ATM;
receiving from said account holder an amount and a type of negotiable instrument to be printed;
confirming that said account has sufficient funds to cover said inputted amount;
generating said negotiable instrument; and
delivering said negotiable instrument via a method selected by said user.

10. The method of claim 9, wherein said delivery method comprises printing said negotiable instrument using a printer associated with said ATM.

11. The method of claim 9, wherein said delivery method comprises mailing said negotiable instrument to an address of said payee.

12. The method of claim 9, further comprising:
determining that said amount exceeds a threshold amount; and
enacting additional security measures regarding said delivering of said negotiable instrument.

13. The method of claim 12, wherein said additional security measures comprise said negotiable instrument being printed at a branch of said bank for pickup by said user.

14. The method of claim 12, wherein said additional security measures comprise capturing an image of said user using a camera associated with said ATM.

15. An ATM comprising:
a touch display;
a processor; and
a printer for printing a negotiable instrument generated by said ATM.

16. The ATM of claim 16, further comprising:
a stylus used to endorse a visualization of said negotiable instrument on said display.

17. The ATM of claim 17, further comprising:
a camera capturing an image of a user of said ATM.
